(19) United States
(12) Patent Application Publication
(10) Pub. No.: US 2021/0352922 A1
(43) Pub. Date: Nov. 18, 2021

(54) PROCESS FOR SMOKING OF FISH, AND A SMOKED FISH PRODUCT

(71) Applicant: BREMNES SEASHORE AS, Bremnes (NO)

(72) Inventors: Svein Olav FJÆRA, SUNNDALSØRA (NO); Jan Ove MORLANDSTØ, Bremnes (NO); Even MANSETH, Molde (NO); Laila KNARVIK, Mosterhamn (NO); Simon NESSE ØKLAND, Bremnes (NO)

(21) Appl. No.: 17/274,109

(22) PCT Filed: Sep. 6, 2019
(86) PCT No.: PCT/NO2019/050177

§ 371 Date: Mar. 5, 2021

(30) Foreign Application Priority Data
Sep. 6, 2018 (NO) 20181165

(51) Int. Cl. A23B 4/044; A23L 17/00; A23B 4/048; A23B 4/03; A22C 25/16; A22C 25/18

(52) U.S. Cl. CPC A23B 4/044; A23L 17/00; A23B 4/048; A23V 2002/00; A22C 25/16; A22C 25/18; A23B 4/03

(57) ABSTRACT

An improved method for the production of a smoked product of fish is described. A product produced by the method is also described.

### FIELD OF THE INVENTION

The present invention relates to a method for smoking of fish and a smoked fish product.

### BACKGROUND TO THE INVENTION

Smoking is a traditional way to preserve fish and fish with a long shelf-life and good taste are obtained. The usual way to smoke fish products such as fish fillets is to slaughter the fish, smoke the fish in a post-rigor phase and this is carried out at reasonably high temperatures.

### OBJECTS OF THE PRESENT INVENTION

It is an object of the present invention to provide a smoked fish product that has improved characteristics compared with today's smoked fish products.

Thus, it is an object of the present invention to provide a method for the smoking of fish products that maintains the freshness of the fish and which achieves better characteristics than today's smoked fish products.

It is also an aim of the present invention to provide smoked fish products which compared with today's smoked fish products show at least one improved characteristic and preferably at least several improved characteristics.

### SUMMARY OF THE INVENTION

Thus, the present invention relates in a first aspect to a method for the production of a smoked fish product, characterised in that the fish is filleted and divided into portions in a pre-rigor state and that the fish is marinated in a pre-rigor state and that the smoking of the fish starts while the fish is in a pre-rigor state and that the smoking of the fish takes place at a temperature in the area 0-9° C.

In one embodiment said smoking process takes place at a temperature below 9° C., preferably 8° C. or lower, more preferred 6° C. or lower and most preferred at a temperature of about 4° C. or lower.

In one embodiment the temperature of the smoke or the smoke agent that is used in the smoking process has a temperature in the area of 0-9° C., more preferred a temperature below 8° C., more preferred below 6° C. and most preferred that it has a temperature below 4° C.

In one embodiment the smoking process is carried out with a method chosen from; i) supplying smoke, ii) supplying smoking acid, iii) supplying smoke aroma and iv) the use of smoking paper.

In one embodiment said marinating is a dry marinating.

In one embodiment said marinating comprises salt and/or sugar, optionally with flavouring additions.

In one embodiment said marinating takes place in 0 to 12 hours, more preferred 0-10 hours, more preferred 0-8 hours and more preferred 0-6 hours.

In one embodiment the fish is kept before slaughtering in a cooling tank at a water temperature in the area of 1-4° C. for 30-120 minutes, more preferably for 50-70 minutes and where the fish after stunning/bleeding is placed to bleed out in water at a temperature in the area of −2 to 3° C. for 30 to 150 minutes, more preferred 60-120 minutes.

In one embodiment the fish is filleted while it has a pH in the area 7.0-7.6.

In one embodiment the fish is rinsed in water after the marinating operation where the water has a temperature in the area of 0-10° C., more preferred below 8° C., more preferred below 6° C. and more preferred below 4° C.

In one embodiment the fish is subjected to a drying process after the rinsing, preferably at a temperature in the area of 0-10° C., more preferred below 4° C. and that the drying time is in the area of 0-15 hours, more preferred 0-10 hours and more preferred 0-6 hours.

In one embodiment the fish is subjected to a drying after smoking at a temperature in the area of 0-10° C., more preferred below 8° C., more preferred below 6° C. and more preferred below 4° C. and where dry air is circulated.

In one embodiment the smoked product is vacuumed and packed within 36 hours after its slaughter, more preferred within 30 hours of its death and more preferred within 24 hours of its death.

In one embodiment the total liquid loss for the smoked product is about 10% or lower.

In one embodiment the total liquid loss for the smoked product is about 7-10% lower than a corresponding smoked product which is smoked in the conventional way (i.e. not at pre-rigor and low temperature).

In one embodiment the whole smoking process is carried out before the fish enters into rigor.

In a second aspect the present invention relates to a smoked fish product characterised in that it is produced and treated as given in any of the method steps given above.

In one embodiment the product has a sensory quality which is an improvement with regard to a corresponding smoked product which is smoked in a conventional method (i.e. not at pre-rigor and low temperature).

In one embodiment the fish is a salmonoid.

In one embodiment the fish is a salmon or a trout.

In one embodiment the fish product is produced from a loin or a whole fillet.

### DESCRIPTION OF PREFERRED EMBODIMENTS OF THE INVENTION

Preferred embodiments of the invention will now be described without this being regarded as limiting for the invention as the invention is defined by the enclosing patent claims.

The inventors of the present invention have surprisingly found that it is possible to achieve an improved smoked fish product by running all the processes from the slaughter of the fish and up to finished smoked product at low temperatures. In addition, one has carried out the marinating and started the smoking process of the product while the fish is still in a pre-rigor phase.

After the slaughter the fish is exposed to a process that is called rigor which leads to the muscular elasticity of the filaments disappearing as a consequence of formation of irreversible cross bonds between the myosin filaments and actin filaments caused by emptying of ATP in the muscle cells. Before this process starts the slaughtered fish will be in a pre-rigor state where the fish is still sensory subtle and with soft and elastic muscles.

The inventors of the present invention have found that it is possible to marinate and start the smoking process of the fish already while it is in such pre-rigor state and that this leads to an improved smoked fish product.

It has been found that freshness is also an important quality parameter for smoked fish products. In addition to the fish being marinated and partially smoked before rigor sets in, the method according to the invention is developed such that all processing steps are carried out at a low temperature, preferably at 4° C. or lower. However, one will also obtain an improved smoked fish product even if some of the processing steps are carried out at somewhat higher temperatures than 4° C.

### EXAMPLE 1

Production of a Smoked Fish Product with Improved Characteristics Live salmon is loaded into a cooling tank at a water temperature of 1-4° C. As farmed salmon is used in this example the fish is transferred to the cooling tank from a holding tank on the shore that has a water temperature of 8-10° C. or directly from a well boat where the temperature corresponds to the surrounding sea temperature or from a holding pen where the temperature also corresponds to the sea temperature. Alternative methods can be used to delay rigor.

The holding time in the cooling tank is 50-70 minutes. The chilled fish is then led to stunning/bleeding before it is led on to bleeding out in cold water (temperature −2 to 3° C.) for 60-120 minutes. The fish is slaughtered (possibly after some intermediate storing for up to 1-4 hours) and is transported further to filleting while it is in the pre-rigor phase. The pH of the fillets in this pre-rigor phase is 7.0-7.6. Thereafter, the fish is subjected to skinning, removal of dark meat and divided into portions. It is, for example, preferred that one divides the fish into three portions; back loin, mid loin and stomach loin. One can also cut the portions in a portion cutter and in this example one has cut the fish into portions of about 170 grams each.

The different portions are then marinated, rinsed and smoked while the fish meat is still in a pre-rigor state. The portions in this example are dry salted (a dry marinade with a salt and sugar mixture is added). This marinade process can take place quickly or up to about 10 hours. It is also possible to add other flavouring compounds to the marinade.

After the marinade process the fish is rinsed in water (temperature preferably below 4° C.) and the fish is thereafter dried before smoking. It is also preferred that the drying process takes place at a low temperature, preferably below 4° C. The drying is sufficiently efficient and lasts sufficiently long enough so that one gets a product which is sufficiently dry so that one gets a good quality for the smoked product. Drying time and drying method can vary but is adjusted to the actual fish product and the water content after marinating and rinsing. For the fish products that are used in this example it has been found that a drying time of up to 2 hours gives a good result.

Thereafter, while the fish portions are still in their pre-rigor state, the fish is smoked. The smoking is carried out in a temperature area of 0-9° C. The temperature during the smoking is for most of the time in the area 6-8° C. It is preferred that the smoking can also be carried out at lower temperatures, such as 4° C. or lower. For the portions that are used in this example the smoking is carried out for 3-6 hours, alternatively for two periods of about 3 hours each and with a rest period of up to 1 hour.

Different methods can be used for the smoking of the fish, such as supplying smoke, addition of smoke acid or smoke aroma and the use of smoking paper or also a combination of such methods.

There are a series of process parameters that can be optimised and the choice of temperature with respect to the necessary process time (as for the drying) will determine how long the whole treatment from the slaughtering to the finished product will take. An important moment with the present invention is that the smoking process starts while the fish is still in the pre-rigor phase. As the processing steps before the smoking takes some time, the fish could possibly go into rigor during the smoking process. The method according to the invention seeks to be optimised such that as much of the smoking process as possible can be carried out pre-rigor. It is preferred that the whole smoking process is finished before the fish goes into rigor.

Thereafter, the finished smoked product is vacuumed and packed, and one ensures that this is carried out carried out at the latest 30-36 hours after the slaughtering. It is preferred that the vacuuming and packaging are also carried out at low temperatures, preferably below 4° C. The product is then stored at 0-4° C. before distribution.

The finished product has a total liquid loss of about 8-10% and this is 7-10% lower than a corresponding product smoked the traditional way. As all the processes are carried out at low temperatures, the fish maintains its freshness longer and has a longer shelf-life than a corresponding product produced with conventional smoking.

1. A method for the production of a smoked fish product, the method comprising the steps of;
filleting and dividing fish into portions in a pre-rigor state;
marinating the fish in the pre-rigor state; and
smoking the fish in a smoking process that starts while the fish is in the pre-rigor state, wherein the smoking process takes place at a temperature in a range of between about 0° C. and about 9° C.

2. The method according to claim 1, wherein the fish is filleted and is divided into portions in the pre-rigor state at 4° C. or lower, and the fish is marinated in the pre-rigor state at 4° C. or lower.

3. The method according to claim 1, wherein all processing steps are carried out at a temperature of 4° C. or lower.

4. The method according to claim 1, wherein the smoking process takes place at a temperature of below 9.

5. The method according to claim 1, wherein the temperature of the smoke or the smoking means that is used in the smoking process has a temperature in a range of between about 0° C. and about 9° C.

6. The method according to claim 1, wherein the smoking process is selected from the group of processes consisting of: i) supplying of smoke, ii) supplying smoke acid, iii) supplying smoke aroma and iv) the use of smoking paper, and combinations thereof.

7. The method according to claim 1, wherein the marinating step comprises a dry marinating process.

8. The method according to claim 1, wherein a marinade used in the marinating step is comprised of salt and/or sugar.

9. The method according to claim 1, wherein the marinating step continues for a time of about 12 hours or less.

10. The method according to claim 1, further comprising the step of keeping the fish in a cooling tank before slaughtering at a water temperature in a range of between about 1° C. and about 4° C. for a time in a range of about 30 minutes to about 120 minutes, wherein after stunning/bleeding the fish is placed to bleed out in water at a temperature in a range of between about −2° C. and about 3° C. for a time in a range of about 30 minutes to about 150 minutes.

11. The method according to claim 1 wherein the fish is filleted while it has a pH in a range of about 7.0 to about 7.6.

12. The method according to claim 6, wherein after the marinating, the fish is rinsed in water at a temperature in a range of between about 0° C. and about 10° C.

13. The method according to claim 12, wherein after the rinsing, the fish is subjected to a drying process at a temperature in a range of between about 0° C. and about 10° C. and that the drying time is about 15 hours or less.

14. The method according to claim 1, wherein after smoking, the fish is subjected to a drying process at a temperature in a range of between about 0° C. and about 10° C. where dry air is circulated.

15. The method according to claim 1, wherein the smoked fish product is vacuumed and packaged within 36 hours from slaughter.

16. The method according to claim 1, wherein the total liquid loss of the smoked fish product is about 10% or lower.

17. The method according to claim 1, wherein the whole smoking process is carried out before the fish goes into rigor.

18. A smoked product of fish, produced and treated as given in the method according to claim 1.

19. The smoked product according to claim 18, wherein the fish is a salmonoid.

20. The smoked product according to claim 18, wherein the fish is salmon or trout.

21. The smoked product according to claim 18, wherein the fish product is produced from a loin or a full fillet.
